(19) United States
(12) Patent Application Publication
(10) Pub. No.: US 2006/0293811 A1
(43) Pub. Date: Dec. 28, 2006

(54) Automotive data logger

(76) Inventors: Keith Andreasen, Huntington Beach, CA (US); Phuong Pham, Westminster, CA (US)

Correspondence Address: STETINA BRUNDA GARRED & BRUCKER, 75 ENTERPRISE, SUITE 250, ALISO VIEJO, CA, 92656, US

(21) Appl. No.: 11/166,719

(22) Filed: Jun. 24, 2005

(51) Int. Cl. G06F 19/00

(52) U.S. Cl. 701/29; 701/35; 340/438

(57) ABSTRACT

A self-contained, hand held automotive diagnostic tool and method for logging automotive diagnostic data is disclosed. An automotive diagnostic tool is connected to a programming device, at which time the tool is programmed to log specified diagnostic data in response to detection of a selected vehicle diagnostic indicator. The tool is then connected to a vehicle diagnostic port, where diagnostic information is received by the tool. The tool detects the occurrence of the specified vehicle diagnostic indicator and logs diagnostic data for a selectable pre-indicator detection period and a selectable post-indicator detection period.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates to automotive diagnostic equipment and, more particularly, to a data logger adapted for programmable retrieval of automotive diagnostic data from a vehicle under test.

Automotive diagnostic equipment functions to access and analyze vehicle diagnostic data generated by a vehicle under test. The automotive diagnostic equipment retrieves diagnostic data from the vehicle's diagnostic computer. In some cases, diagnostic tools or code readers are vehicle specific, that is the tools are currently programmed to access, store and output a prescribed set of diagnostic data that is generated by a particular vehicle. In other cases, the diagnostic tools are programmably configurable to access and retrieve data from a variety of different vehicles. Such programmability provides greater flexibility and use of the code reader, though may also add complexity to the operation. As such, diagnostic tools, particularly those intended for use by ordinary, non-professional consumers, must balance capability and complexity and allow broad general use of the tool.

One automotive code reader adapted for broad general use by the general consuming public is the Model 3173 Code Reader marketed by Equus Products, Inc. That code reader allows the user to access and retrieve diagnostic indicators from a wide range of vehicles, and provides a trouble indicator upon receipt of a diagnostic trouble code. The trouble indicator alerts the user that some problem may exist, and allows the user to then access more detailed information, or take the user to an automotive professional, for further evaluation.

Another contemporary device which allows a user to readily evaluate diagnostic indicators within a vehicle is the Model 3100 OBD II Code Reader, also marketed by Equus Products, Inc. That code reader incorporates a diagnostic display which, within a single screen, allows the user to identify the presence of diagnostic trouble codes and PIDs representative of the potential trouble indicators within the vehicle. By incorporating such an all in one display, there is little need for a user to navigate a user interface in order to obtain information regarding the diagnostic status of a vehicle.

While the above devices provide ease of use and allow general consumers to perform many diagnostic functions, certain functions remain difficult to implement, particularly on a handheld diagnostic tool. For example, certain diagnostic indicators may occur only intermittently. While the occurrence of such indicators may be recorded in a readable diagnostic module, the sequence of indicators leading to or resulting from such an intermittent indicator may be unclear from simply a record of diagnostic indicators. As such, it is desirable to be able to capture data indicative of the diagnostic indicators about a point in time that a trouble indicator is detected, e.g. a diagnostic trouble code or PID. By examining such contemporaneous data, additional information can be evaluated that may assist in diagnosing trouble indicators within a vehicle. Preferably the event triggering such a diagnostic record can be selected to more particularly identify temporal diagnostic indicators about a particular diagnostic indicator of interest. It is also preferable to allow programmable selection of the record period during which diagnostic indicators are monitored and recorded in a scan tool memory. Further capabilities of significant utility for such a scan tool include automatic linking to a vehicle diagnostic port and/or a personal computer, for ease of receiving diagnostic information and communicating that information to a local or remote computer for analysis.

The constructions described below are directed to implementing some or all of the above referenced features, as well as other features, to provide a versatile diagnostic tool, having simplicity of operation sufficient to allow use by the general consuming public.

### BRIEF SUMMARY OF THE INVENTION

The present invention allows a user to create a log of diagnostic data for a vehicle under test. Specifically, the present invention allows a user to log diagnostic data relating to a specified diagnostic indicator for a selectable period of time prior to and after the detection of the diagnostic indicator.

In accordance with the present invention there is provided an automotive diagnostic tool. The automotive diagnostic tool connects to a programming device, such as a personal computer, by way of a programming connector port located on the tool. The programming device programs the tool to log specified diagnostic data in response to detection of a specified vehicle diagnostic indicator, or combination of indicators. A specified vehicle diagnostic indicator is a particular piece of diagnostic data which indicates the diagnostic status of a specific system within a vehicle. For example, the specified vehicle diagnostic indicator may be a specified vehicle diagnostic trouble code, or PID. The user may also program the diagnostic tool to log data for a selectable pre-indicator detection period as well as a selectable post-indicator detection period. The selectable pre-indicator detection period is a programmable time frame prior to the detection of the specified vehicle diagnostic indicator during which diagnostic data is logged. The selectable post-indicator detection period is a programmable time frame following the detection of the specified vehicle diagnostic indicator during which diagnostic data is logged. The selectable detection periods may be of the same duration, or of different durations, depending on how the tool is programmed.

After the tool has been programmed, the tool's vehicle connector port is connected to a vehicle diagnostic port located on the vehicle, allowing the tool to communicate with the vehicle's diagnostic computer. At this time, the tool may communicate the specified vehicle diagnostic indicator to the vehicle's diagnostic computer. The tool may then indicate to the diagnostic computer that it is interested in receiving data relating to the specified diagnostic indicator. However, the tool is not limited to only receiving data relating to the specified diagnostic indicator. The tool may be programmed to log all available data, or data from a variety of sources upon detection of the specified diagnostic indictor in order to get a better understanding of how the vehicle as a whole is operating.

The tool continually receives diagnostic data from the diagnostic computer while it is connected to the vehicle diagnostic port. As the tool receives the data, the data is buffered, or briefly stored in a buffer circuit, while a detector circuit inspects the currently secured data for the presence of the specified diagnostic indicator. The buffer circuit allows the tool to store data for a limited period of time; therefore, if the designated diagnostic indicator is detected, there is a temporary record of pre-indictor detection data already stored. That temporary record is logged, along with post-indicator detection data in the long-term memory to create the final data record. However, if the diagnostic indicator is not detected, the data that has been temporarily stored may be deleted, and replaced with new data.

Once the data record has been created, the tool may display the diagnostic information on a display device. The display device may be located on the tool, or alternatively, the tool may be connected to an external display device, such as a personal computer, through a display connector port.

An additional step may be uploading logged diagnostic data from the tool to a communication device, such as a personal computer, cellphone, or PDA, where the communication device is capable of transmitting the diagnostic data to an application program or automotive professional for evaluation and/or further assistance.

### BRIEF DESCRIPTION OF THE DRAWINGS

FIG. 1 is a block diagram showing the relationships between the different components of the invention.

FIG. 2 is a detailed diagram of the elements comprising the preferred embodiment of the automotive diagnostic tool.

FIG. 3 is a detailed diagram of the elements comprising an additional embodiment of the automotive diagnostic tool.

### DETAILED DESCRIPTION OF THE INVENTION

The detailed description, as set forth below in connection with the appended drawings, is intended as a description of the presently preferred embodiments of the invention, and is not intended to represent the only form in which the present invention may be constructed or utilized.

Every automobile is comprised of many different systems. As a car operates, the various systems within the car continuously transmit data relating to the diagnostic condition of the system to an on-board diagnostic computer. This data will hereinafter be referred to as diagnostic data. As a problem develops within one of the vehicle's systems, the system sends a diagnostic indicator to the diagnostic computer to alert the computer of the problem. The present invention is a method of logging automotive diagnostic data sent by the various systems located throughout a vehicle in response to the detection of a specified vehicle diagnostic indicator.

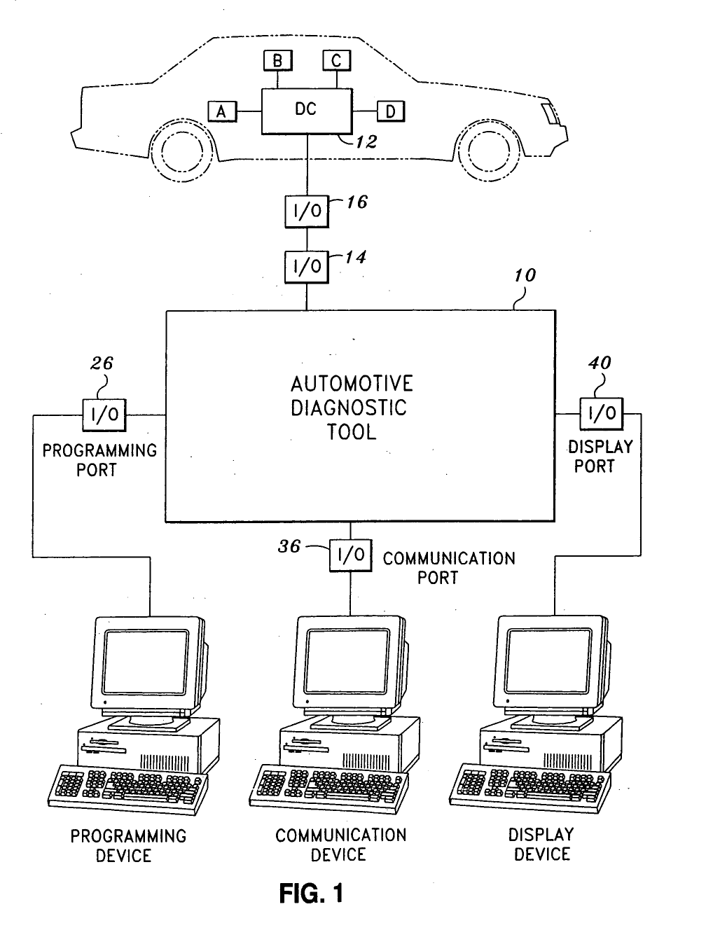

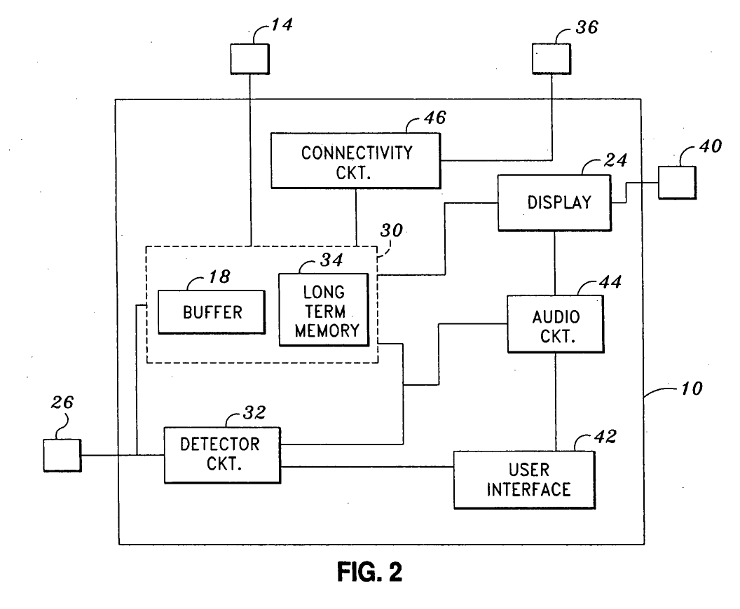

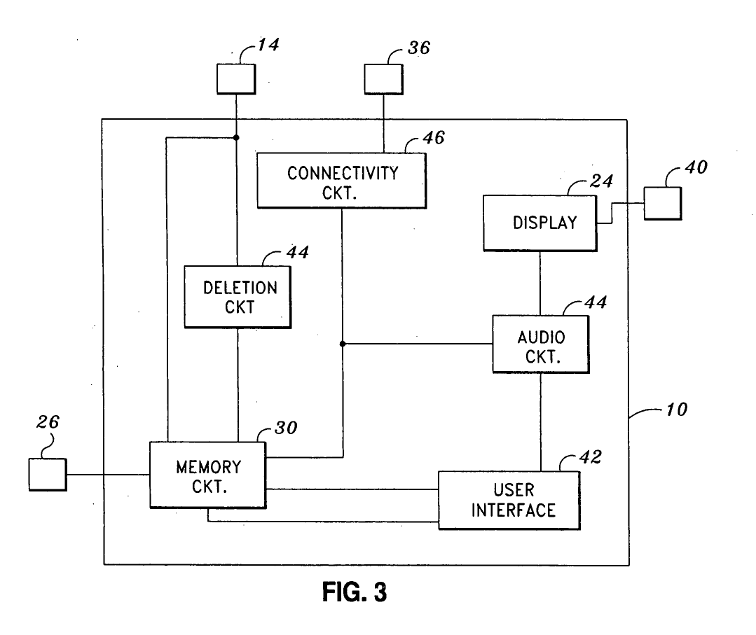

Referring now to the drawings wherein the showings are for the purposes of illustrating preferred embodiments of the present invention only, and not for the purposes of limiting the same, FIG. 1 is a block diagram illustrating the relationship among the different components used throughout the method of logging automotive diagnostic data. FIG. 2 is a detailed drawing showing the various elements of the self-contained, hand held automotive diagnostic tool 10. FIG. 3 is a detailed drawing of an additional embodiment of the automotive diagnostic tool 10.

The self-contained, hand held automotive diagnostic tool 10 contains a programming connector port 26, which is connectable to a programming device 28. The programming device 28 can program the tool 10 to log diagnostic data in response to detection of a specified vehicle diagnostic indicator, or combination of indicators. A vehicle diagnostic indicator is a specific piece(s) of diagnostic data relating to a particular diagnostic condition(s) about which the user desires to log data. The user can program the tool 10 to log data in response to the detection of a specified diagnostic indicator(s) to obtain a data record focused on a particular system within the car. However, the user may want a data record that encompasses a number of systems. In such a case, the user could program the tool 10 to record diagnostic data in response to the detection of a number of indicators. It is desirable to log such diagnostic data because it allows the user to view multiple operating conditions of a specific system(s) before and after the diagnostic indicator was triggered. Though knowledge of the diagnostic indicator will alert the user of a problem, it may not be sufficient to identify the solution to the problem. The ability to analyze the indicator, in cooperation with a record of the diagnostic data before and after the detection of the diagnostic indicator will give the user a better understanding of the likely cause(s) of the problem.

In addition to programming the tool to respond to a specified vehicle diagnostic indicator, the user can also program the time period for which the tool 10 logs diagnostic data. Diagnostic data can be logged for a selectable pre-indicator detection period, as well as a post-indicator detection period. The tool 10 can be programmed to log diagnostic data where the detection periods are the same duration or of different durations. Depending on the specified diagnostic indicator(s), there may be advantages of having detection periods that are the same duration, or of different durations.

The tool 10 can also have an additional operating mode wherein the user merely programs the specified diagnostic indicator, or combination of indicators into the tool 10, and the tool 10 automatically logs diagnostic data. In one such embodiment, the tool 10 can log the available data for a predetermined period of time before and after the detection of the indicator. Alternatively, the tool 10 automatically determines which data to log as well as the duration of the pre-indicator and post-indicator detection periods based on the specified diagnostic indicator programmed into the tool 10 by the user.

The tool 10 can have a further operating mode wherein the user does not program the tool 10 at all. In this mode, the tool 10 operates autonomously by logging available diagnostic data as soon as any indicator, or any set of indicators is detected.

The programming device may also be used to program the tool 10 to a vehicle specific setting. For instance, the tool 10 may be compatible with a wide variety of vehicles and engines. In this situation, the programming device would program the tool 10 to the specific vehicle under test. This may include programming the tool 10 to a specific make, model, manufacturer, year, and engine. Alternatively, the tool 10 may be pre-programmed to be compatible with one specific make or model of vehicle, and may not be compatible with other vehicles. In such a case, the tool 10 would not require vehicle specific programming.

In another embodiment of the present invention, the tool 10 would have an accessible database within the tool. This would eliminate the need to connect the tool 10 with the programming device 28. In this situation, a user interface 42 located on the tool would allow a user to access the internal database, and select the programming functions described above.

After the automotive diagnostic tool 10 has been programmed, it connects with the specific vehicle under test. The vehicle connector port 14, located on the tool 10, connects with the vehicle diagnostic port 16, such as a USB connector port, located on the vehicle. This connection allows the tool 10 to communicate the specified vehicle diagnostic indicator to the vehicle's diagnostic computer 12. The diagnostic computer 12, in turn, sends the specified live diagnostic data to the tool 10.

In another embodiment of the present invention, the diagnostic computer 12 would transmit all diagnostic data to the tool 10. The tool 10 would subsequently recognize data relating to the diagnostic indicator from the other information sent by the diagnostic computer 12. Only the data relating to the specified diagnostic indicator would be logged by the tool 10.

As the tool 10 receives diagnostic data from the vehicle, it sends the data to a memory circuit 30. In the preferred embodiment of the present invention, as can be seen in FIG. 2, the memory circuit 30 is comprised of a buffer circuit 18, and a long-term memory circuit 34. The buffer circuit 18 gates the diagnostic information received from the vehicle, while a detector circuit 32 searches through the data for the presence of the selected vehicle diagnostic indicator. The length of time for which the buffer circuit 18 temporarily holds the data is at least equal to the pre-indictor detection period, e.g. ten (10) seconds. This allows the memory circuit 30 to hold data received prior to the detection of the diagnostic indicator without having to store the data in the long term memory circuit 34. Where the data within the buffer circuit is determined to contain the specified vehicle diagnostic indicator, that data, as well as preceding and, subsequent data can be logged into the long-term memory circuit 34. If the data within the buffer circuit 18 does not contain the selected vehicle diagnostic indicator, new diagnostic data is gated into the buffer circuit 18, while the previously received data passes out of the buffer circuit 18, without being logged into the long-term memory circuit 34.

In an additional embodiment of the present invention, as can be seen in FIG. 3, the tool 10 would not gate the diagnostic data. Rather, the tool 10 would log the all diagnostic data on the memory circuit 30. A deletion circuit 44 would subsequently search through the stored data for the presence of the specified diagnostic indicator. If the indicator was not found within the stored data, the deletion circuit 44 would delete the data. However, if the diagnostic data did contain the specified diagnostic indicator, the deletion circuit 44 would not delete the stored data for the selectable pre-indicator and post-indicator detection periods.

After the diagnostic data is logged by the tool 10, the data can be displayed on a display device. The preferred embodiment of the invention would display the information on a display screen 24 located on the face of the tool 10. However, if the tool 10 does not have a display screen 24, an external display device 28, such as a computer or PDA, may be connected to the tool 10 through a display connector port 40, located on the tool 10. The external display device 28 would be capable of displaying the data logged by the tool 10.

In addition to displaying the diagnostic data, the tool 10 may also be capable of communicating the diagnostic data. The tool 10 connects to a communication device 28 through a communication connector port 36 located on the tool 10, or through a local connectivity circuit 46, e.g. Bluetooth™ or WiFi, incorporated into the tool, and in communication with a local connectivity network, e.g. in communication with a cellphone or local computer system. The logged diagnostic data may, therefore be uploaded onto the communication device 28, such as a computer, cellphone, or PDA. Once the data is uploaded onto the communication device 28, the diagnostic data may be communicated to a number of automotive professionals for bids on fixing the problem.

In an effort to create a more user-friendly automotive diagnostic tool 10, the present invention may provide audio signals in response to a variety of different operating conditions. For example, an audio circuit 44 within the tool 10 may generate an audio signal in response to an electrical linkage of the tool 10 with the automotive diagnostic port 16, or to a programming device 28 via the programming connector port 26. Additionally, the tool 10 may generate an audio signal in response to uploading diagnostic data to the tool 10 from the automotive diagnostic port 16.

Still further embodiments and enhancements of the present invention will be apparent to those of ordinary skill in the art, with the broad scope of the present invention.

What is claimed is:

1. A method of logging automotive diagnostic data with a self-contained, hand-held automotive diagnostic tool comprising the steps of:
a. connecting the automotive diagnostic tool to a programming device;
b. programming the tool to log specified diagnostic data in response to detection of a specified vehicle diagnostic indicator(s);
c. connecting the tool to a vehicle diagnostic port to receive diagnostic data therefrom;
d. detecting the occurrence of the specified vehicle diagnostic indicator(s); and
e. logging diagnostic data for a selectable pre-indicator detection period and a selectable post-indicator detection period.

2. The method as recited in claim 1 wherein the programming device is a personal computer.

3. The method as recited in claim 1 wherein the specified vehicle diagnostic indicator(s) comprises detection of a specified vehicle diagnostic trouble code(s).

4. The method as recited in claim 1 wherein the selectable pre-indicator detection period and the selectable post-indicator detection period are the same duration.

5. The method as recited in claim 1 wherein the selectable pre-indicator detection period and the selectable post-indicator detection period are of different durations.

6. The method as recited in claim 1 further comprising the step of communicating the specified vehicle diagnostic indicator(s) from the automotive diagnostic tool to the vehicle's diagnostic computer.

7. The method as recited in claim 1 further comprising the step of receiving diagnostic data from the vehicle's diagnostic computer.

8. The method as recited in claim 1 further comprising the step of continually receiving diagnostic data from the vehicle diagnostic port while the automotive diagnostic tool is connected to the vehicle diagnostic port, wherein the diagnostic data is momentarily held for detection of the specified vehicle diagnostic indicator(s).

9. The method as recited in claim 1 further comprising the step of displaying diagnostic data logged by the automotive diagnostic tool.

10. The method as recited in claim 9 wherein the diagnostic data is displayed on a display screen located on the automotive diagnostic tool.

11. The method as recited claim 9 wherein the diagnostic data is displayed on an external display device.

12. The method as recited in claim 11 wherein the external display device is a personal computer.

13. The method as recited in claim 1 further comprising the step of transferring logged diagnostic data from the automotive diagnostic tool to a communication device.

14. The method as recited in claim 13 wherein the communication device is a personal computer.

15. The method as recited in claim 13 wherein the communication device is a PDA.

16. The method as recited in claim 1 further comprising the step of programming the tool to a vehicle specific setting.

17. The method as recited in claim 16 wherein the vehicle specific setting may include data identifying the year, manufacturer, model or engine of a vehicle to be tested.

18. The method as recited in claim 1 further comprising the step of generating an audio connect signal in response to electrical linking of the automotive diagnostic tool to the vehicle, diagnostic port.

19. The method as recited in claim 1 further comprising the step of generating an audio connect signal in response to electrical linking of the automotive diagnostic tool to the programming device.

20. The method as recited in claim 1 further comprising the step of generating an audio data load signal in response to transferring of diagnostic data to the automotive diagnostic tool from the vehicle diagnostic port.

21. A self-contained, hand held automotive diagnostic tool comprising:
a. a vehicle connector port for connecting the automotive diagnostic tool to a vehicle diagnostic port on a vehicle;
b. a detector circuit in communication with the vehicle connector port, the detector circuit being programmable to detect a specified vehicle diagnostic indicator(s) from the diagnostic data received from the vehicle connector port; and
c. a memory circuit in communication with the vehicle connector port and the detector circuit, the memory circuit being operative to temporarily store diagnostic data for a specified period of time, and to log stored diagnostic data in response to the detection of the specified vehicle diagnostic indicator(s), for a specified pre-indicator detection period and a specified post-indicator detection period.

22. The tool as recited in claim 21 wherein the memory circuit is comprised of:
a. a buffer circuit, operative to temporarily store diagnostic data for a preset period of time; and
b. a long-term memory circuit, operative to log diagnostic data for a specified pre-indicator detection period and for a specified post-indicator detection period.

23. The tool as recited in claim 21 further comprising a communication connector port for connecting the automotive diagnostic tool to a communication device.

24. The tool as recited in claim 21 further comprising a connectivity circuit for connecting the automotive diagnostic tool to external devices.

25. The tool as recited in claim 21 further comprising a programming connector port for connecting the automotive diagnostic tool to a programming device.

26. The tool as recited in claim 21 further comprising a display connector port for connecting the automotive diagnostic tool to an external display device;

27. The tool as recited in claim 21 further comprising a database of vehicle specific diagnostic information, the database being configurable to interface the tool with a specific vehicle in response to program instructions from the computer.

28. The tool as recited in claim 21 further comprising a user interface for programming the automotive diagnostic tool.

29. The tool as recited in claim 25 wherein the programming device is a personal computer.

30. The tool as recited in claim 23 wherein the communication device is a personal computer.

31. The tool as recited in claim 23 wherein the communication device is a PDA.

32. The tool as recited in claim 21 wherein the specified vehicle diagnostic indicator(s) comprises a selected PID.

33. The tool as recited in claim 21 wherein the specified vehicle diagnostic indicator(s) comprises a selected diagnostic trouble code(s).

34. A self-contained, hand held automotive diagnostic tool comprising:
a. a vehicle connector port for connecting the automotive diagnostic tool to a vehicle diagnostic port on a vehicle;
b. a memory circuit in communication with the vehicle connector port, the memory circuit being operative to store the diagnostic data received from the vehicle; and
c. a deletion circuit in communication with the memory circuit, the deletion circuit being operative to scan the data within the memory circuit for the specified vehicle diagnostic indicator and delete data not within the selectable pre-indicator detection period or the post-indicator detection period.

35. The tool as recited in claim 34 further comprising a connectivity circuit for connecting the automotive diagnostic tool to external devices.
